(19) United States
(12) Patent Application Publication
(10) Pub. No.: US 2003/0130134 A1
(43) Pub. Date: Jul. 10, 2003

(54) Macrospheres for dual gradient drilling

(75) Inventor: Robert Kenneth Oram, Aberdeen (GB)

Correspondence Address: BANNER & WITCOFF, 1001 G STREET N W, SUITE 1100, WASHINGTON, DC, 20001, US

(73) Assignee: Balmoral Group Ltd, Aberdeen (GB)

(21) Appl. No.: 10/060,397

(22) Filed: Feb. 1, 2002

(30) Foreign Application Priority Data
Jan. 4, 2002 (GB) 02 00 112.1

(51) Int. Cl. C09K 7/00

(52) U.S. Cl. 507/118

(57) ABSTRACT

A method of preparing a pressure resistant sphere comprising the steps of

iv) introducing a plurality of expandable beads into a spherical mould;

v) expanding said beads to form a sphere;

vi) coating said sphere with a pressure resistant coating.

### FIELD OF THE INVENTION

This invention relates to macrospheres. More especially but not exclusively the invention relates to macrospheres for dual gradient drilling.

### THE BACKGROUND & PROBLEMS

In oilfield drilling, recirculating dense slurries of insoluble materials (“drilling muds”) are used to lubricate the drill bit and carry cuttings back to the drilling rig for separation and mud recovery. The mud density or “weight” is selected so that the hydraulic head of fluid maintains the pressure in the annular space between the drill bit and the surrounding reservoir structure above the natural pressure generated by the reservoir contents (the “blow out pressure”). There is however also a maximum allowable mud density as the achieved pressure in the annular space from the hydraulic head of mud has to be below the “fracture pressure” of the oil-bearing structure. The drill rig operator therefore controls his mud density to operate within the “safe band” between “blow out pressure” and “fracture pressure”. In onshore and shallow water offshore rigs, the blow out pressures are relatively modest, so mud density control is relatively straightforward. In deepwater offshore drilling however, reservoir blow out pressures are significantly higher, narrowing the “safe band”. Additionally, the freedom to control mud density in the “safe band” is restricted due to the hydraulic head exerted in the annular space outside the drillstring by the 3,000-6,000 m (10-20,000 ft) extended column of mud within the drillstring bore hole and its continuation within the drilling riser.

Deepwater oil exploration drilling would be greatly simplified if the apparent depth of the seabed could be artificially reduced, effectively disassociating the surface/seabed well hole conditions and the seabed/drill bit conditions. This concept is termed “Dual Gradient Drilling” to reflect the targeted discontinuity in pressure gradient conditions between the drill bit and the ocean surface which occurs at the seabed. The recognised standard method of achieving this discontinuity is to provide seabed mud lift pumps, which create an “artificial surface” at the seabed, returning mud to the platform independent of drilling rig mud feed control. These seabed mud lift pump systems pose enormous technical challenges, as they have to operate for long periods without maintenance in massive water depths and handle extremely abrasive and aggressive combinations of chemicals and rock fragments.

An alternative concept of the Dual Gradient Drilling which entirely eliminates the problems associated with seabed mud pumps is the “Hollow Sphere Lift” concept, where lightweight hollow spheres are injected into the returning mud column at the seabed, to significantly reduce its density and thereby the hydraulic head exerted upon the oil-bearing structures.

Currently-available commercial supply of suitably pressure rated hollow spheres is limited to hollow glass microspheres (typical diameter 50-150 microns) and fiber-reinforced thermoset resin minispheres (diameter 6 mm-15 mm). Hollow glass microspheres have the required collapse pressure and density (200-400 bar [3,000-6,000 psi] @ 4-60° C., density 300-500 kg/m³) and have actually been used for trial dual gradient drilling. They have proved however extremely difficult to separate from the returning mud and cuttings, as is required to allow return of “heavy” mud to the bore hole and of glass microspheres to the seabed injection point.

Fiber-reinforced thermoset resin minispheres are readily available due to their routine use in deepwater buoyancy products. whilst these spheres are more readily separated from the returning cuttings and mud mix, they still have substantial performance deficiencies. For example the production process is based on the over-coating of an expanded polystyrene (“EPS”) core with thermoset resin and fiber reinforcement. This EPS core is in turn produced by the heat-softening of a solid polystyrene prill containing a volatile liquid (typically pentane) as a blowing agent. The size and sphericity of the EPS sphere is dependent upon the size and sphericity of the polystyrene prill. The polystyrene prill is produced by a “prilling” process, i.e. the production and cooling/solidification of molten polystyrene droplets. There is a maximum prill size that can be produced (approx 3 mm diameter) as larger molten droplets are unstable and split. The largest available sizes of prill are themselves not perfectly spherical, as they are approaching the “instability” size, whilst the cooling and shrinking of the liquid large droplet creates a small “dimple” in the sphere surface, as solidification and shrinkage of the last liquid within the droplet takes place. The result of these production constraints is that the ultimate size of the polystyrene spheres after expansion is limited to absolute maximum 15 mm (typically under 12 mm) at 10 kg/m³ final density, whilst the spheres themselves are some way short of perfect sphericity.

The final coating process of the EPS “sphere” with thermoset resin and mineral fibers is relatively inefficient on spheres of diameter <15 mm, due to relatively high surface area:volume (weight) ratio, so that spheres of relatively inconsistent coating thickness are produced.

As the maximum possible collapse pressure of a sphere requires uniform wall thickness and perfect sphericity, the deficiencies in both wall thickness and sphericity of the currently-available thermoset resin composite spheres inevitably results in substantially lowered burst pressure for a given true density. In other words spheres of higher density must be used to meet collapse/burst pressure requirements. This higher density both increases cost and potentially ultimately limits the extent of mud density reduction that is achievable at maximum sphere loading in the mud.

The aim of the Hollow Sphere Lift concept of Dual Gradient Drilling is to negate the effect of the “excess density” (between mud density and seawater density) of the extended mud column between surface and seabed. The magnitude of the “excess density” that must be negated (typically 500-700 kg/m³), plus the limiting practical quantity (volume fill) of spheres that can be incorporated into the returning mud column (absolute maximum about 50%, ideally <40%), places severe limitations on the allowable sphere density. In practice, with the currently commercially available sphere size and composition, (max 12 mm dia, glass, mineral or carbon fiber reinforcement, rigid thermoset resin e.g. epoxy, polyester, vinyl ester, phenolic etc) spheres of sufficiently-low density to meet mud density reduction requirements have hydrostatic collapse pressure only slightly greater than the required service pressures. There is thus only very limited scope for any reduction in sphere collapse resistance/pressure during service before sphere collapse becomes a major problem.

Unfortunately, over relatively short periods of time, migration of the drilling mud base fluid (typically water, or organic fluids such as hydrocarbons or esters) into the molecular structure of the fiber-binding resin takes place. This leads to a reduction in Glass Transition Temperature (Tg) of the resin (the temperature at which the thermoset polymer changes from a hard glassy material, capable of providing support to reinforcing fibers into an elastomeric/rubber-like material, incapable of providing significant support to reinforcing fibers). As the Glass Transition Temperatures (Tg) falls and moves closer to the mud operating temperature (up to 60-70° C.), mechanical properties of the thermoset resin composite are progressively lost. For the fiber-reinforced, thermoset resin (FRP) sphere, this loss of Tg is manifested as a loss of hydrostatic collapse pressure, so that, at a certain level of Tg reduction, the sphere eventually fails by hydrostatic collapse. As the rate of solvent penetration is a function of sphere wall thickness, and as only very thin sphere walls are possible with 12 mm (max) spheres at acceptable densities, sphere collapse occurs within hours or days of entry into service which is unacceptable.

Whilst the current fiber-reinforced thermoset resin (FRP) spheres are of suitable size to be removed by simple mechanical means such as sieves or shakers, the sphere size (6-15 mm) is too close to that of drill cuttings to allow a single stage separation. It is therefore necessary to provide a 2 stage separation process, e.g. initial screening to remove liquid mud and then a second step for cuttings/spheres separation, e.g. by floatation and skimming of the hollow spheres from the heavy cuttings. With the limited deck space and allowable weights, the second separation stage is a significant problem.

The currently-available FRP spheres are far too large to be handled in slurry form by one of the standard designs of pump employed for handling glass microsphere-based slurries and liquid syntactics. Equally, the spheres are insufficiently large to be readily forced through pipe by liquid back pressure. The best that can be achieved is to sweep them between points by liquid flow, in relatively “lean phase” systems, thus limiting ultimate volume fill rates in the returning column, unless special seabed sphere separation/re-introduction systems are provided. This installation of complex materials processing equipment on the deepwater seabed is exactly the concept the DGD Hollow Sphere Lift Process is designed to eliminate.

The current invention seeks to eliminate or at least reduce these problems.

### STATEMENT OF THE INVENTION

In accordance with the invention a large for example 20-450 mm low density sphere for example of EPS is provided and then overcoated. The large sphere can be made by providing a spherical mould, introducing a plurality of expandable beads into the mould and expanding the beads.

### BRIEF DESCRIPTION OF DRAWINGS

Embodiments of the invention will be described by way of non-limiting example by reference to the accompanying figures of which

FIG. 1 is a cross-section of a sphere of the invention (with the wall thickness not shown to scale);

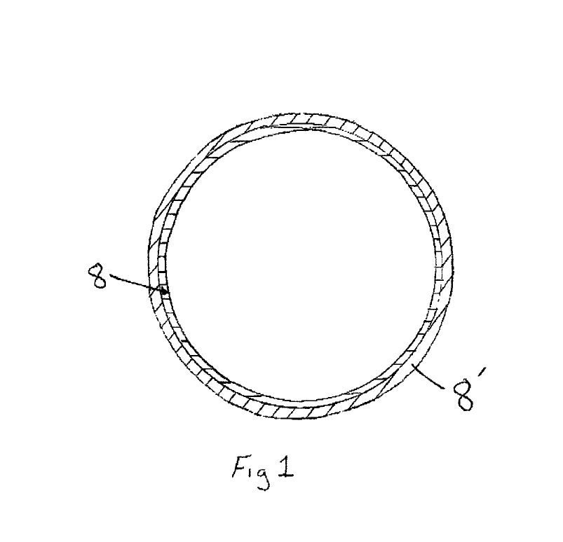

FIG. 2 is a cross-sectional view of a mould containing expandable beads;

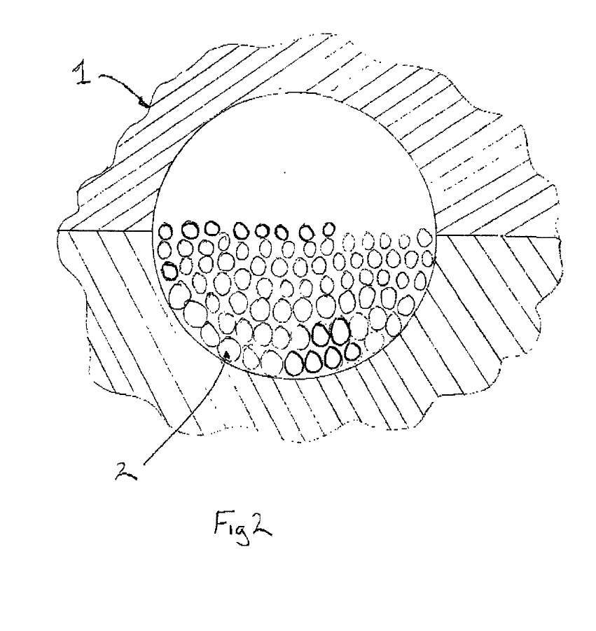

FIG. 3 is a cross-sectional view of a tumbler; and

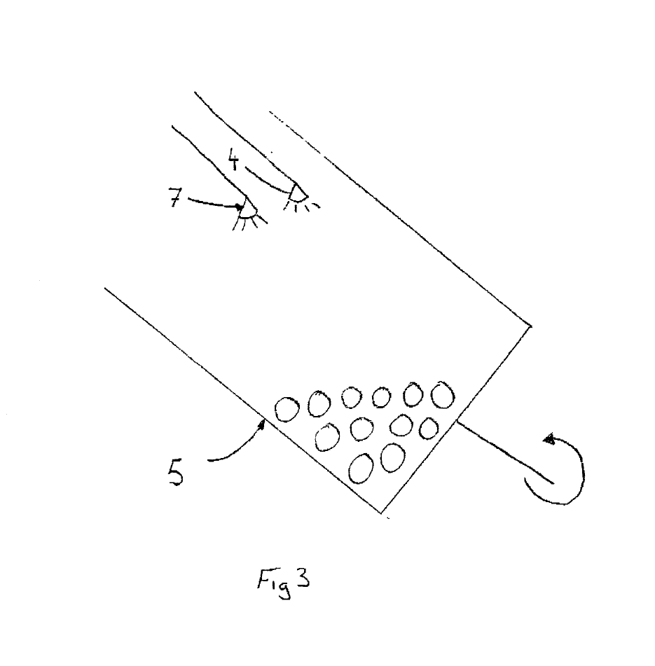

FIG. 4 is a graph of burst pressure and density for spheres of the invention and for prior art spheres.

### DESCRIPTION OF PREFERRED EMBODIMENTS

In a first step a spherical mould 1 is filled with expandable beads or prills 2 for example of polystyrene. The mould can be machined in known ways to approach a truly spherical cavity. The beads or prills are then expanded for example by heat or steam. They expand and coalesce, filling the spherical cavity and forming a spherical ball. Since the mould is a close approximation to a true sphere the moulded polystyrene ball will be a close approximation to a sphere and more closely spherical than if it had been prepared by expanding a large single prill. The sphere produced will generally be found to have few if any surface defects. By appropriate selection of the mould spheres of almost any size can be produced. For practical purposes spheres may typically be of a diameter in the range 40 to 250 mm.

The polystyrene spheres can then be coated to produce a pressure resistant sphere. Those skilled will have no difficulty in devising suitable ways of coating the polystyrene sphere.

In a preferred embodiment of the invention a layer of curable epoxy resin is applied to the outside of the polystyrene for example by spraying from spray head 4 while the spheres are in a tumbler 5. Reinforcing fibers for example of carbon, glass mineral or metal are then applied to the epoxy resin for example from head 7. The epoxy resin is then cured for example by hot air to give coating layer 8.

It will be apparent to the skilled worker in the art that it is not essential to use epoxy resins other materials such as thermosetting resins for example phenolics, phenolic epoxies, vinyl esters, polyesters can be employed.

The process can be repeated a number of times to provide a plurality, typically seven to one hundred coating layers 8, 8′. It will be apparent that they layers need not all be of the same thickness or composition.

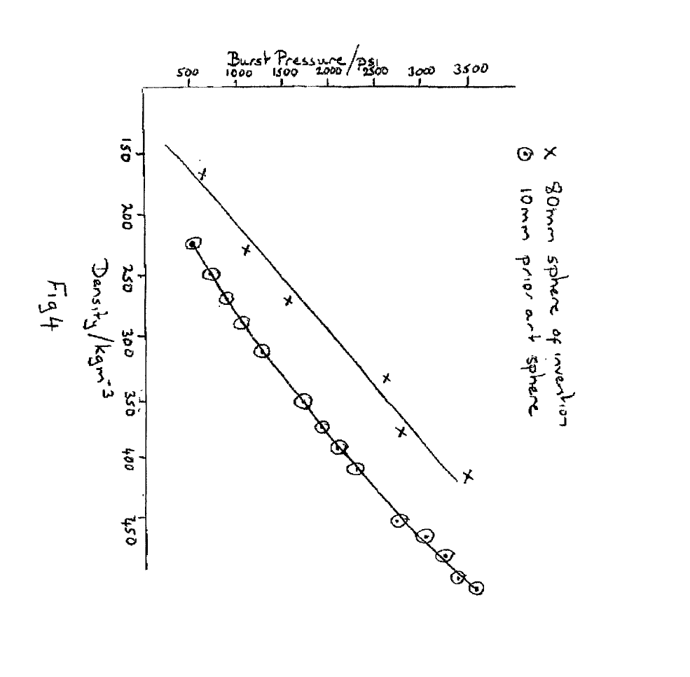

The spheres of the invention can have superior properties to known spheres. FIG. 4 shows a graph plotting the density of a range of spheres against their burst pressure. Two series of spheres were examined. One series was a conventional 10 mm sphere made by expanding a single polystyrene prill and then coating with epoxy resin and fiber and the other series was of 80 mm sphere made in accordance with the invention and coated with the same materials. It will be noted that for a given burst pressure the spheres of the invention are of much lower bulk density. As hereinbefore noted low bulk density is desirable in promoting reduction in the bulk density of the mud in the string. Secondly as noted large spheres are much more easily separated from the slurry of mud, chippings and spheres than small spheres. Thirdly as again noted large spheres can have relatively thick walls and still maintain acceptably low densities thereby maintaining the Tg at an acceptable high level in the presence of drilling mud base fluid.

Table 1 shows the effect of maintaining 80 mm macrospheres and comparative 10 mm minispheres in an oil and water-based muds for extended periods. In use in dual gradient drilling the spheres will not generally be subjected to elevated pressure at all times: the spheres are during part of the use cycle above the surface on the rig being separated, cleaned or stored for re-injection. To replicate this the spheres were subjected to elevated pressure, reflecting seabed hydrostatic pressures encountered in modern ultradeepwater drilling for 9 hours in each 24 hours. When not under pressure the spheres were maintained in the mud since solvent ingress and hence reduction in Tg is not strongly dependent on pressure.

It will be noted that after only a few days at 40° C. 25% of the prior art spheres had failed in the oil based mud while none of this of the invention had failed. Degradation of the order observed with the l0mm spheres is unacceptable. Failure of the prior art spheres in a water based mud was even more dramatic: total failure occurred in about the same time. Testing was not complete for the spheres of the invention in an oil based mud but significant failure in such a short time is not anticipated.

TABLE 1
Oil Based Mud

| | | 80 mm | 80 mm | 10 mm | 10 mm |
|---|---|---|---|---|---|
| Total | Hours at | macro | macro | mini | mini |
| Hours | Pressure | Ambient | 40° C. | Ambient | 40° C. |
| 24.67 | 9.25 | 100 | 100 | 100 | 100 |
| 63.33 | 23.75 | 100 | 100 | 100 | 100 |
| 111.25 | 41.72 | 100 | 100 | 100 | 100 |
| 180 | 67.5 | 100 | 100 | 100 | 96 |
| 223.33 | 83.75 | 100 | 100 | 100 | 92 |
| 266 | 99.75 | 100 | 100 | 100 | 84 |
| 308.67 | 115.75 | 100 | 100 | 100 | 75 |

Water Based Mud

| Total | Hours at | 10 mm mini | 10 mm mini |
|---|---|---|---|
| Hours | Pressure | Ambient | 40° C. |
| 24.67 | 9.25 | 100 | 100 |
| 23.75 | 23.75 | 100 | 100 |
| 111.25 | 41.72 | 100 | 100 |
| 180 | 67.5 | 100 | 96 |
| 223.33 | 83.75 | 100 | 86 |
| 266 | 99.75 | 100 | 70 |
| 308.67 | 115.75 | 100 | 55 |
| | | | failed |
| | | | off test |

Water Based mud

| | | 80 mm | 80 mm |
|---|---|---|---|
| Total | Hours at | macro | macro |
| hours | Pressure | Ambient | 40° C. |
| 0 | 0 | 100 | 100 |
| 42.66 | 16 | 100 | 100 |
| 128 | 48 | 100 | 100 |

While invention has been described by reference to one way of preparing the spheres it will be apparent that the truly spherical EPS or other material spheres could be made in other ways. Accordingly the invention is not so limited.

Those skilled in the art will have no difficulty in devising modifications. In particular while the invention has been described by reference to dual gradient drilling it will be apparent to the skilled worker that the spheres of the invention will have other applications where some or all of the properties of the spheres of the invention are useful.

I claim:

1. A method of preparing a pressure resistant sphere comprising the steps of
i) introducing a plurality of expandable beads into a spherical mould;
ii) expanding said beads to form a sphere;
iii) coating said sphere with a pressure resistant coating.

2. The method of claim 1 wherein said beads are generally spherical with a diameter no greater than 4 mm.

3. The method of claim 1 wherein said beads comprise polystyrene.

4. The method of claim 1 wherein said sphere obtained in step iii) is coated with an epoxy resin and fibers.

5. The method of claim 1 wherein said coating comprises a plurality layers.

6. The method of claim 4 wherein said fibers are selected from the group consisting of carbon fibers, glass fibers, mineral fibers and metal fibers.

7. A pressure resistant sphere obtainable by the method of claim 1.

8. A pressure resistant sphere obtained by the method of claim 1.

9. A drilling mud comprising a plurality of spheres as claimed in claim 7.

10. The use of spheres as claimed in claim 7 in reducing the bulk density of drilling mud.
